(19) United States
(12) Patent Application Publication
(10) Pub. No.: US 2020/0124172 A1
(43) Pub. Date: Apr. 23, 2020

(54) VEHICLE DRIVE-FORCE TRANSMITTING APPARATUS

(71) Applicant: TOYOTA JIDOSHA KABUSHIKI KAISHA, Toyota-shi (JP)

(72) Inventors: Hiromitsu NITANI, Okazaki-shi (JP); Yusuke OHGATA, Miyoshi-shi (JP); Yoshinobu SOGA, Toyota-shi (JP); Shinji OITA, Toyota-shi (JP)

(73) Assignee: TOYOTA JIDOSHA KABUSHIKI KAISHA, Toyota-shi (JP)

(21) Appl. No.: 16/572,794

(22) Filed: Sep. 17, 2019

(30) Foreign Application Priority Data
Oct. 18, 2018 (JP) 2018-197048

(51) Int. Cl. F16H 61/70; F16D 25/12; F16D 21/00; F16D 41/16; F16D 41/04

(52) U.S. Cl. CPC F16H 61/702; F16D 25/12; F16H 37/065; F16D 41/16; F16D 41/04; F16D 21/00

(57) ABSTRACT

A vehicle drive-force transmitting apparatus defines drive-force transmitting paths provided between input and output shafts. The drive-force transmitting paths include a first drive-force transmitting path provided with first and auxiliary engagement devices, such that the auxiliary engagement device is located between the first engagement device and the output shaft in the first drive-force transmitting path. The first drive-force transmitting path is established by engagement of the first engagement device operated by a hydraulic pressure which is controlled by an on-off solenoid valve, such that a drive force is to be transmitted along the first drive-force transmitting path through the first and auxiliary engagement devices when the first drive-force transmitting path is established. The auxiliary engagement device transmits a drive force during a driving state of the vehicle and cuts off transmission of the drive force during a driven state of the vehicle.

This application claims priority from Japanese Patent Application No. 2018-197048 filed on Oct. 18, 2018, the disclosure of which is herein incorporated by reference in its entirety.

### FIELD OF THE INVENTION

The present invention relates to reduction of cost for manufacturing a vehicle drive-force transmitting apparatus that is constructed to define a plurality of drive-force transmitting paths.

### BACKGROUND OF THE INVENTION

There is known a drive-force transmitting apparatus that is to be provided in a vehicle, wherein the drive-force transmitting apparatus defines a plurality of drive-three transmitting paths provided between an input shaft and an output shaft of the drive-force transmitting apparatus, and includes engagement devices configured to connect and disconnect the drive-force transmitting paths. As an example of such a drive-force transmitting apparatus, Patent Document 1 discloses a hybrid driving apparatus. In the hybrid driving apparatus disclosed in the Japanese Patent Application Publication, in a switching transition from one of the drive-force transmitting paths to another of the drive-force transmitting paths (in a process of a shifting action in the Patent Document 1), a shock generated in the switching transition is minimized or reduced by a so-called “clutch-to-clutch control” that is executed for engaging an engagement device (that is to be engaged) while releasing another engagement device (that is to be released).

### PRIOR ART LITERATURES

### Patent Documents

Patent Document 1: JP2015-113932A
Patent Document 2: JP2014-4941A

### SUMMARY OF THE INVENTION

By the way, for executing the clutch-to-clutch control, a liner solenoid valve is required to finely control a hydraulic pressure applied to the engagement device that is to be engaged and another liner solenoid valve is required to finely control a hydraulic pressure applied to the other engagement device that is to be released. However, a linear solenoid valve is expensive, so that there has been a problem that the use of a linear solenoid valve or valves increases the manufacturing cost.

The present invention was made in view of the background art described above. It is therefore an object of the present invention to provide a drive-force transmitting apparatus that is to be provided in a vehicle, wherein the drive-force transmitting apparatus defines a plurality of drive-force transmitting paths and includes engagement devices configured to connect and disconnect the drive-force transmitting paths, and wherein the drive-force transmitting apparatus has a construction by which the manufacturing cost can he reduced. This object is achieved according to the following aspects of the present invention.

According to a first aspect of the invention, there is provided a drive-force transmitting apparatus that is to be provided in a vehicle, the drive-force transmitting apparatus includes an input shaft, an output shaft, a first engagement device and an auxiliary engagement device, wherein the drive-force transmitting apparatus defines a plurality of drive-force transmitting paths that are provided between the input shaft and the output shaft, wherein the plurality of drive-force transmitting paths include a first drive-force transmitting path that is provided with the first engagement device and the auxiliary engagement device, such that the auxiliary engagement device is located between the first engagement device and the output shaft in the first drive-force transmitting path, wherein the first drive-force transmitting path is established by engagement of the first engagement device operated by a hydraulic pressure which is applied to the first engagement device and which is controlled by an on-off solenoid valve (that is a simple solenoid valve that is to be placed in either one of an open position and a closed position, without an operation position intermediate between the open and closed positions), such that a drive force is to be transmitted along the first drive-force transmitting path through the first and auxiliary engagement devices when the first drive-force transmitting path is established, and wherein the auxiliary engagement device is configured to transmit the drive force during a driving state of the vehicle and to cut off transmission of the drive force during a driven state of the vehicle. It is noted that the feature regarding to the auxiliary engagement device (which is described that the auxiliary engagement device is configured to transmit the drive force during a driving state of the vehicle and to cut off transmission of the drive force during a driven state of the vehicle) may be described alternatively that the auxiliary engagement device includes an input-side rotary portion and an output-side rotary portion such that rotation is to be transmitted between the input shaft and the input-side rotary portion along the first drive-force transmitting path and such that rotation is to be transmitted between the output-side rotary portion and the output shaft along the first drive-force transmitting path, wherein the input-side rotary portion is inhibited from being rotated in a predetermined one of opposite directions relative to the output-side rotary portion and is allowed to be rotated in the other of the opposite directions relative to the output-side rotary portion. Further, for example, the input-side rotary portion of the auxiliary engagement device is connected to a first rotary element and is to be rotated integrally with the first rotary element, wherein the output-side rotary portion of the auxiliary engagement device is connected to a second rotary element and is to be rotated integrally with the second rotary element, and wherein, when the first and second engagement devices are both engaged and the input shaft is rotated, the first and second rotary elements are both rotated such that a rotational speed of the second rotary element is higher than a rotational speed of the first rotary element, whereby the input-side rotary portion of the auxiliary engagement device is rotated in the other of the opposite directions relative to the output-side rotary portion of the auxiliary engagement device. It is further noted that, for example, the drive-force transmitting apparatus includes a hydraulic control unit that includes the on-off solenoid valve.

According to a second aspect of the invention, in the drive-force transmitting apparatus according to the first aspect of the invention, the on-off solenoid valve is isolated from hydraulic actuators of engagement device that are other than the first engagement device.

According to a third aspect of the invention, in the drive-force transmitting apparatus according to the first or second aspect of the invention, there is further provided a second engagement device, wherein the plurality of drive-force transmitting paths further include a second drive-force transmitting path that is established by engagement of the second engagement device operated by a hydraulic pressure which is applied to the second engagement device and which is controlled by a linear solenoid valve, such that the drive three is to be transmitted along the second drive-force transmitting path through the second engagement device when the second drive-force transmitting path is established, and wherein one of the first and second drive-force transmitting paths is switched to the other of the first and second drive-force transmitting paths, by engagement of a corresponding one of the first and second engagement devices and release of the other of the first and second engagement devices. For example, the second drive-force transmitting path provides a second gear ratio between the input and output shafts, and the first drive-force transmitting path provides a first gear ratio between the input and output shafts, such that the second gear ratio is lower than the first gear ratio.

According to a fourth aspect of the invention, in the drive-force transmitting apparatus according to the third aspect of the invention, there is further provided a continuously-variable transmission, wherein the first and second drive-force transmitting paths are provided in parallel with each other, and wherein the second drive-force transmitting path is provided with the continuously-variable transmission.

According to a fifth aspect of the invention, in the drive-force transmitting apparatus according to any one of the first through fourth aspect of the invention, the auxiliary engagement device is to be placed in a selected one of a one-way mode and a lock mode, such that the auxiliary engagement device is configured to transmit the drive force during the driving state of the vehicle and to cut off transmission of the drive force during the driven state of the vehicle when the auxiliary engagement device is placed in the one-way mode, and such that the auxiliary engagement device is configured to transmit the drive force during the driving state of the vehicle and during the driven state of the vehicle when the auxiliary engagement device is placed in the lock mode.

In the drive-force transmitting apparatus according to the first aspect of the invention, the first drive-force transmitting path is provided with the first engagement device and the auxiliary engagement device. Owing to this arrangement, although the hydraulic pressure applied to the first engagement device is controlled by the on-off solenoid valve, the vehicle is enabled to run in substantially the same manner as in an arrangement in which the hydraulic pressure applied to the first engagement device is controlled by a linear solenoid valve. For example, in a switching transition between the first drive-force transmitting path and another one of the drive-force transmitting paths, a torque transmitted through the first drive-three transmitting path is appropriately adjusted by the auxiliary engagement device, whereby a shock can be reduced as in a case in which the clutch-to-clutch control is executed. Further, since a solenoid valve used to control the hydraulic pressure applied to the first engagement device is constituted by the on-off solenoid valve, the manufacturing cost can be made lower than an arrangement in which the solenoid valve used to control the hydraulic pressure applied to the first engagement device is constituted by a linear solenoid valve,

In the drive-force transmitting apparatus according to the second aspect of the invention, the on-off solenoid valve is isolated from hydraulic actuators of engagement device that are other than the first engagement device. Therefore, since the on-off solenoid valve does not control the hydraulic pressures applied to the hydraulic actuators of the engagement devices other than the first engagement device, it is possible to avoid a shock, which could be generated if the hydraulic pressures applied to the engagement devices other than the first engagement device were controlled by the on-off solenoid valve.

In the drive-force transmitting apparatus according to the third aspect of the invention, the hydraulic pressure applied to the second engagement device is controlled by the linear solenoid valve. Therefore, in a switching transition between the first drive-force transmitting path and the second drive-force transmitting path, a shock generated in the switching transition can be reduced with the hydraulic pressure applied to the second engagement device being finely controlled by the linear solenoid valve.

In the drive-force transmitting apparatus according to the fourth aspect of the invention, when the second drive-force transmitting path is established by engagement of the second engagement device being engaged, the vehicle is enabled to run with execution of shifting actions in the continuously variable transmission that is provided in the second drive-force transmitting path.

In the drive-force transmitting apparatus according to the fifth aspect of the invention, the auxiliary engagement device is to be placed in a selected one of the one-way mode and the lock mode. Therefore, for example, when the vehicle is caused to run by an inertia with the first drive-force transmitting path being established to be placed in a drive-force transmittable state, the auxiliary engagement device can be placed in the lock mode, thereby enabling an engine brake to be generated by drag of a drive force source that is caused by rotation of drive wheels transmitted to the drive force source through the auxiliary engagement device that is placed in the lock mode.

### BRIEF DESCRIPTION OF THE DRAWINGS

FIG. 1 is a schematic view showing a construction of a vehicle that includes a drive-force transmitting apparatus according to the present invention;

FIG. 2 is a view schematically showing a construction of a two-way clutch shown in FIG. 1, wherein the view is a cross sectional view of a circumferential portion of the two-way clutch, taken in a plane perpendicular to a radial direction of the two-way clutch, and shows the two-way clutch in its one-way mode;

FIG. 3 is a view schematically showing the construction of the two-way clutch shown in FIG. 1, wherein the view is the cross sectional view of the circumferential portion, taken in the plane perpendicular to the radial direction of the two-way clutch, and shows the two-way clutch in its lock mode;

FIG. 4 is a table indicating an operation state of each of engagement devices for each of operation positions which is selected by operation of a manually-operated shifting device in the form of a shift lever that is provided in the vehicle; and

FIG. 5 is a view schematically showing a hydraulic control unit configured to control operation states of a continuously variable transmission and a drive-force transmitting apparatus shown in FIG. 1.

### DETAILED DESCRIPTION OF PREFERRED EMBODIMENT

Hereinafter, a preferred embodiment of the invention will be described in detail with reference to the accompanying drawings. The figures of the drawings are simplified or deformed as needed, and each portion is not necessarily precisely depicted in terms of dimension ratio, shape, etc.

### Embodiment

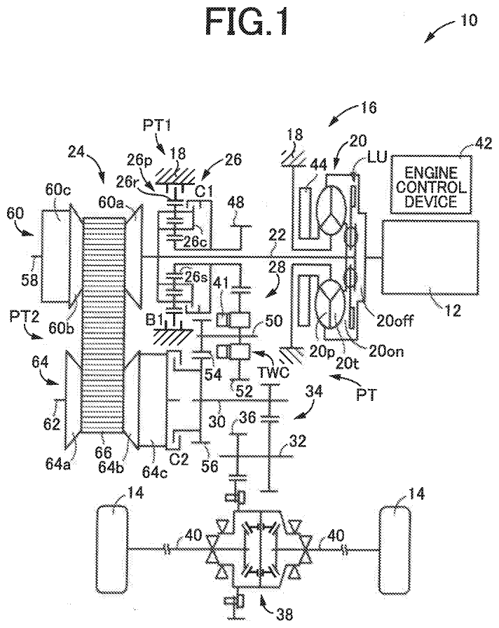

FIG. 1 is a schematic view showing a construction of a vehicle 10 to be controlled by a control apparatus according to the present invention. As shown in FIG. 1, the vehicle 10 is provided with an engine 12 functioning as a drive force source configured to generate a drive force, drive wheels 14 and a vehicle drive-force transmitting apparatus 16 that is configured to transmit the drive force of the engine 12 to the drive wheels 14.

The drive-force transmitting apparatus 16 includes a non-rotary member in the form of a casing 18, a fluid-operated type drive-force transmitting device in the form of a known torque converter 20 that is connected to the engine 12, an input shaft 22 connected to the torque converter 20, a belt-type continuously variable transmission 24 connected to the input shaft 22, a forward/reverse switching device 26 connected to the input shaft 22, a gear mechanism 28 which is provided in parallel with the continuously variable transmission 24 and which is connected to the input shaft 22 via the forward/reverse switching device 26, an output shaft 30 serving as an output rotary member that is common to the continuously variable transmission 24 and the gear mechanism 28, a counter shaft 32, a reduction gear device 34 consisting of a pair of mutually meshing gears each of which is connected to a corresponding one of the output shaft 30 and the counter shaft 32 so as to unrotatable relative to the corresponding one of the shafts 30, 32, a gear 36 connected to the counter shaft 32 so as to be unrotatable relative to the counter shaft 32, a differential gear device 38 connected to the gear 36 in a drive-force transmittable manner, and right and left axles 40 that connect the differential gear device 38 to the respective right and left drive wheels 14. The torque converter 20, input shaft 22, continuously variable transmission 24, forward/reverse switching device 26, gear mechanism 28, output shaft 30, counter shaft 32, reduction gear device 34, gear 36 and differential gear device 38 are disposed within the casing 18.

In the drive-force transmitting apparatus 16 constructed as described above, the drive force generated by the engine 12 is transmitted to the right and left drive wheels 14, via the torque converter 20, forward/reverse switching device 26, gear mechanism 28, reduction gear device 34, differential gear device 38, axles 40 and other elements, or alternatively, via the torque converter 20, continuously variable transmission 24, reduction gear device 34, differential gear device 38, axles 40 and other elements. It is noted that the above-described drive force is synonymous with a drive torque or a drive power unless otherwise distinguished from them.

The drive-force transmitting apparatus 16 defines a first drive-force transmitting path PT1 and a second drive-force transmitting path PT2 that are provided in parallel with each other between the input shaft 22 and the output shaft 30, such that the drive force of the engine 12 is to be transmitted along a selected one of the first and second drive-force transmitting paths PT1, PT2 from the input shaft 22 to the output shaft 30. The first drive-force transmitting path PT1 is provided with the gear mechanism 28 While the second drive-force transmitting path PT2 is provided with the continuously variable transmission 24. Thus, the drive-force transmitting apparatus 16 has a plurality of drive-force transmitting paths in the form of the first and second drive-force transmitting paths PT1, PT2, which are provided in parallel with each other between the input shaft 22 and the output shaft 30.

The first drive-force transmitting path PT1 is provided with: the forward/reverse switching device 26 including a first clutch C1 and a first brake B1; the gear mechanism 28; and a two-way clutch TWC serving as an auxiliary engagement device, and is a drive-force transmitting path along which the drive force of the engine 12 is to be transmitted from the input shaft 22 to the drive wheels 14 through the gear mechanism 28. In the first drive-force transmitting path PT1, the forward/reverse switching device 26, gear mechanism 28 and two-way clutch TWC are arranged in this order of description in a direction away from the engine 12 toward the drive wheels 14, so that the two-way clutch TWC is provided between the first clutch C1 (that is included in the forward/reverse switching device 26) the output shaft 30 in the first drive-force transmitting path PT1. It is noted that the two-way clutch TWC corresponds to “auxiliary engagement device” recited in the appended claims.

The second drive-force transmitting path PT2 is provided with the continuously variable transmission 24 and a second clutch C2, and is a drive-force transmitting path along which the drive force of the engine 12 is to be transmitted from the input shaft 22 to the drive wheels 14 through the continuously variable transmission 24. In the second drive-force transmitting path PT2, the continuously variable transmission 24 and second clutch C2 are arranged in this order of description in a direction away from the engine 12 toward the drive wheels 14.

The continuously variable transmission 24, which is provided in the second drive-force transmitting path PT2, includes a primary shaft 58 provided to be coaxial with the input shaft 22 and connected integrally to the input shaft 22, a primary pulley 60 connected to the primary shaft 58 and having a variable effective diameter, a secondary shaft 62 provided to be coaxial with the output shaft 30, a secondary pulley 64 connected to the secondary shaft 62 and having a variable effective diameter, and a transfer element in the form of a transmission belt 66 looped over or mounted on the pulleys 60, 64. The continuously variable transmission 24 is a known belt-type continuously-variable transmission in which the drive force is transmitted owing to a friction force generated between the transmission belt 66 and each of the pulleys 60, 64, and is configured to transmit the drive force of the engine 12 toward the drive wheels 14.

The gear mechanism 28, which is provided in the first drive-force transmitting path PT1, provides a gear ratio EL (=input-shaft rotational speed Nin/output-shaft rotational speed Nout) that is higher than a highest gear ratio in the second drive-force transmitting path PT2 which corresponds to a highest gear ratio γmax of the continuously variable transmission 24. That is, the gear ratio EL of the gear mechanism 28, which may be interpreted also as a gear ratio in the first drive-force transmitting path PT1, is set to be a gear ratio that provides a lower speed than the highest gear ratio γmax, so that a gear ratio (second gear ratio) established in the second drive-force transmitting path PT2 provides a higher speed than the gear ratio EL (first gear ratio) established in the first drive-force transmitting path PT1. It is noted that the input-shaft rotational speed Nin is a rotational speed of the input shaft 22 and that the output-shaft rotational speed Nout is a rotational speed of the output shaft 30.

In the drive-force transmitting apparatus 16, one of the first and second drive-force transmitting paths PT1, PT2, which is selected depending on a running state of the vehicle 10, is established, and the drive force of the engine 12 is transmitted to the drive wheels 14 along the established one of the first and second drive-force transmitting paths PT1, PT2. Therefore, the drive-force transmitting apparatus 16 includes a plurality of engagement devices for selectively establishing the first and second drive-force transmitting paths PT1, PT2. The plurality of engagement devices include the above-described first clutch C1, first brake B1, second clutch C2 and two-way clutch TWC.

The first clutch C1, which is provided in the first drive-force transmitting path PT1, is an engagement device which is configured to selectively connect and disconnect the first drive-force transmitting path PT1, and which is configured, when the vehicle 10 is to run in forward direction, to enable the drive force to be transmitted along the first drive-force transmitting path PT1, by being engaged. The first brake B1, which is also provided in the first drive-force transmitting path PT1, is an engagement device which is configured to selectively connect and disconnect the first drive-force transmitting path PT1, and which is configured, when the vehicle 10 is to run in reverse direction, to enable the drive force to be transmitted along the first drive-force transmitting path PT1 by being engaged. The first drive-force transmitting path PT1 is established by engagement of either the first clutch C1 or the first brake B1. It is noted that the first clutch C1 corresponds to “first engagement device” recited in the appended claims.

The second clutch C2, which is provided in the second drive-force transmitting path PT2, is an engagement device which is configured to selectively connect and disconnect the second drive-force transmitting path PT2, and which is configured, when the vehicle 10 is to run in forward direction, to enable the drive force to be transmitted along the second drive-force transmitting path PT2, by being engaged. Each of the first clutch C1, first brake B1 and second clutch C2 is a known hydraulically-operated wet-type frictional engagement device that is to be frictionally engaged by operation of a hydraulic actuator. Each of the first clutch C1 and first brake B1 constitutes a part of the forward/reverse switching device 26. It is noted that the second clutch C2 corresponds to “second engagement device” recited in the appended claims.

The two-way clutch TWC, which is also provided in the first drive-force transmitting path PT1, is to be placed in a selected one of a one-way mode and a lock mode, such that the two-way clutch TWC is configured to transmit the drive force during a driving state of the vehicle 10 in the forward running and to cut off transmission of the drive force during a driven state of the vehicle 10 in the forward running when the two-way clutch TWC is placed in the one-way mode, and such that the two-way clutch TWC is configured to transmit the drive force during the driving state of the vehicle 10 and during the driven state of the vehicle 10 when the two-way clutch TWC is placed in the lock mode. For example, with the first clutch C1 being placed in the engaged state and with the two-way clutch TWC being placed in the one-way mode, the drive force is transmittable along the first drive-force transmitting path PT1 during the driving state of the vehicle 10 during which the vehicle 10 runs in forward direction by the drive force of the engine 12. That is, during the forward running of the vehicle 10, the drive force of the engine 12 is transmitted to the drive wheels 14 along the first drive-force transmitting path PT1. On the other hand, during the driven state of the vehicle 10, for example, during an inertia running of the vehicle 10 in forward direction, rotation transmitted from the drive wheels 14 is blocked by the of the two-way clutch TWC even when the first clutch C1 is in the engaged state. It is noted that the driving state of the vehicle 10 is a state in which a torque applied to the input shaft 22 takes a positive value so as to act on the input shaft 22 in a direction corresponding to a direction of the running of the vehicle 10, namely, practically, a state in which the vehicle 10 is driven by the drive force of the engine 12. It is further noted that the driven state of the vehicle 10 is a state in which a torque applied to the input shaft 22 takes a negative value so as to act on the input shaft 22 in a direction opposite to a direction of the running of the vehicle 10, namely, practically, a state in which the vehicle 10 is caused to run by an inertia with the engine 12 being dragged by rotation transmitted from the drive wheels 14.

Further, in a state in which the two-way clutch TWC is in the lock mode with the first clutch C1 being in the engaged state, the drive force is enabled to be transmitted through the two-way clutch TWC during the driven state of the vehicle 10 as well as during the driving state of the vehicle 10. In this state, the drive force of the engine 12 is transmitted to the drive wheels 1.4 along the first drive-force transmitting path PT1, and, during the driven sate of the vehicle 10 such as the inertia running, the rotation transmitted from the drive wheels 14 is transmitted to engine 12 along the first drive-force transmitting path PT1 whereby the engine 12 is dragged to generate an engine brake. Further, in a state in which the two-way clutch TWC is in the lock mode with the first brake B1 being in the engaged state, the drive force of the engine 12 is transmitted to the drive wheels 14 through the two-way clutch TWC along the first drive-force transmitting path PT1 and acts on the drive wheels 14 so as to force the drive wheels 14 to be rotated in a direction that causes the vehicle 10 to run in reverse direction. Thus, in this state, the vehicle 10 is enabled to run in the reverse direction with the drive force transmitted along the transmitting path PT1 to the drive wheels 14. The construction of the two-way clutch TWC will be described later.

The engine 12 is provided with an engine control device 42 including an electronic throttle device, a fuel injection device, an ignition device and other devices that are required for controlling an output of the engine 12. In the engine 12, the engine control device 42 is controlled, by an electronic control apparatus (not shown), based on an operation amount θacc of an accelerator pedal 45 that corresponds to a required drive force of the vehicle 10 required by an operator of the vehicle 10, whereby an engine torque Te as an output torque of the engine 12 is controlled.

The torque converter 20 is provided between the engine 12 and the continuously variable transmission 24, and includes a pump impeller 20p and a turbine impeller 20t, such that the pump impeller 20p is connected to the engine 12 while the turbine impeller 20t is connected to the input shaft 22. The torque converter 20 is a fluid-operated type drive-force transmitting device configured to transmit the drive force of the engine 12 to the input shaft 22. The torque converter 20 is provided with a known lock-up clutch LU disposed between the pump impeller 20p and the turbine impeller 20t that serve as an input rotary member and an output rotary member of the torque converter 20, respectively, so that the pump impeller 20p and the turbine impeller 20t, namely, the engine 12 and the input shaft 22, can be directly connected to each other through the lock-up clutch LU, depending on the running state of the vehicle 10. The engine 12 and the input shaft 22 are directly connected to each other through the lock-up clutch LU, for example, when the vehicle 10 runs at a speed within a relatively high speed range.

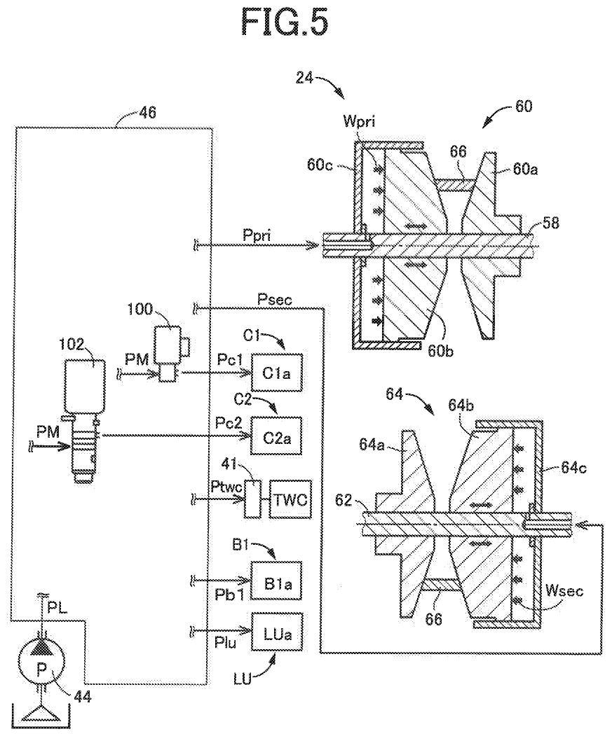

The drive-force transmitting apparatus 16 is provided with a mechanical oil pump 44 connected to the pump impeller 20p. The oil pump 44 is to be driven by the engine 12, to supply a working fluid pressure as its original pressure to a hydraulic control unit (hydraulic control circuit) 46 (see FIG. 5) that is provided in the vehicle 10, for performing a shifting control operation in the continuously-variable transmission 24, generating a belt clamping force in the continuously-variable transmission 24, switching the operation state of the lock-up clutch LU and switching the operation state of each of the above-described engagement devices between its engaged state and released state, or between its one-way mode and lock mode.

The forward/reverse switching device 26 includes a planetary gear device 26p of double-pinion type in addition to the first clutch C1 and the first brake B1. The planetary gear device 26p is a differential mechanism including three rotary elements consisting of an input element in the form of a carrier 26c, an output element in the form of a sun gear 26s and a reaction element in the form of a ring gear 26r. The carrier 26c is connected to the input shaft 22. The ring gear 26r is operatively connected to the casing 18 through the first brake B1. The sun gear 26s is disposed radially outside the input shaft 22, and is connected to a small-diameter gear 48 that is rotatable relative to the input shaft 22. The carrier 26c and the sun gear 26s are operatively connected to each other through the first clutch C1.

The gear mechanism 28 includes, in addition to the above-described small-diameter gear 48, a gear-mechanism counter shaft 50 and a large-diameter gear 52 which meshes with the small-diameter gear 48 and which is mounted on the counter shaft 50, rotatably relative to the counter shaft 50. The gear mechanism 28 further includes a counter gear 54 and an output gear 56. The counter gear 54 is mounted on the counter shaft 50, unrotatably relative to the counter shaft 50, and meshes with the output gear 56 that is mounted on the output shaft 30. It is noted that the large-diameter gear 52 and the counter gear 54 correspond to “first and second rotary elements”, respectively, which are recited in the appended claims.

The two-way clutch TWC is provided between the large-diameter gear 52 and the counter gear 54 in an axial direction of the counter shaft 50, such that the two-way clutch TWC is located to be closer, than the first clutch C1 and the gear mechanism 28, to the drive wheels 14 in the first drive-force transmitting path PT1: The two-way clutch TWC is provided between the first clutch C1 and the drive wheels 14 in the first drive-force transmitting path PT1. The two-way clutch TWC is switchable between the one-way mode and the lock mode by operation of a hydraulic actuator 41 that is disposed to be adjacent to the two-way clutch TWC in the axial direction of the counter shaft 50, so as to be placed in a selected one of the one-way mode and the lock mode.

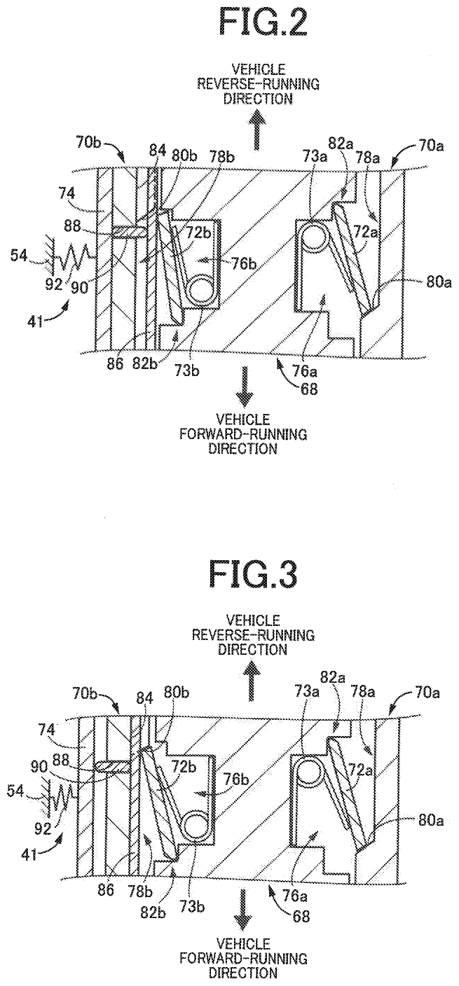

Each of FIGS, 2 and 3 is a view schematically showing a construction of the two-way clutch TWC, which enables switching between the one-way mode and the lock mode, wherein the view is a cross sectional view of a circumferential portion of the two-way clutch, taken in a plane perpendicular to a radial direction of the two-way clutch TWC. FIG. 2 shows a state in which the two-way clutch TWC is placed in the one-way mode. FIG. 3 shows a state in which the two-way clutch TWC is placed in the lock mode. In each of FIGS. 2 and 3, a vertical direction on the drawing sheet corresponds to a circumferential direction of the two-way clutch TWC, an upward direction on the drawing sheet corresponds to a vehicle reverse-running direction (i.e., direction of rotation for reverse running of the vehicle 10) and a downward direction on the drawing sheet corresponds to a vehicle forward-running direction (i.e., direction of rotation for forward running of the vehicle 10). Further, in each of FIGS. 2 and 3, a horizontal direction on the drawing sheet corresponds to the axial direction of the counter shaft 50 (hereinafter, the term “axial direction” means the axial direction of the counter shaft 50 unless otherwise specified), a rightward direction on the drawing sheet corresponds to a direction toward the large-diameter gear 52 shown in FIG. 1, and a leftward direction on the drawing sheet corresponds to a direction toward the counter gear 54 shown in FIG. 1.

The two-way clutch TWC has generally a disk shape, and is disposed radially outside the counter shaft 50. The two-way clutch TWC includes an input-side rotary member 68, first and second output-side rotary members 70a, 70b that are disposed to be adjacent to the input-side rotary member 68 so as to be located on respective opposite sides of the input-side rotary member 68 in the axial direction, a plurality of first struts 72a and a plurality of torsion coil springs 73a that are interposed between the input-side rotary member 68 and the first output-side rotary member 70a in the axial direction, and a plurality of second struts 72b and a plurality of torsion coil springs 73b that are interposed between the input-side rotary member 68 and the second output-side rotary member 70b in the axial direction. It is noted that the input-side rotary member 68 constitutes “input-side rotary portion (of the two-way clutch)” recited in the appended claims, and that the first and second output-side rotary members 70a, 70b cooperate with each other to constitute “output-side rotary portion (of the two-way dutch)” recited in the appended claims.

The input-side rotary member 68 has generally a disk shape, and is rotatable relative to the counter shaft 50 about an axis of the counter shaft 50. The input-side rotary member 68 is located between the first and second output-side rotary members 70a, 70b (hereinafter referred to as output-side rotary members 70 when they are not to be particularly distinguished from each other) in the axial direction. The input-side rotary member 68 is formed integrally with the large-diameter gear 52, such that teeth of the larger-diameter gear 52 are located radially outside the input-side rotary member 68. The input-side rotary member 68 is connected to the engine 12, in a drive-force transmittable manner, through the gear mechanism 28 and the forward/reverse switching device 26, for example.

The input-side rotary member 68 has, in its axial end surface that is opposed to the first output-side rotary member 70a in the axial direction, a plurality of first receiving portions 76a in which the first struts 72a and the torsion coil springs 73a are received. The first receiving portions 76a are equi-angularly spaced apart from each other in a circumferential direction of the input-side rotary member 68. Further, the input-side rotary member 68 has, in another axial end surface thereof that is opposed to the second output-side rotary member 70b in the axial direction, a plurality of second receiving portions 76b in which the second struts 72b and the torsion coil springs 73b are received. The second receiving portions 76b are equi-angularly spaced apart from each other in the circumferential direction of the input-side rotary member 68. The first and second receiving portions 76a are substantially aligned in a radial direction of the input-side rotary member 68.

The first output-side rotary member 70a has generally a disk-shaped, and is rotatable about the axis of the counter shaft 50. The first output-side rotary member 70a is unrotatable relative to the counter shaft 50, so as to be rotated integrally with the counter shaft 50. The first output-side rotary member 70a is connected to the drive wheels 14, in a drive-force transmittable manner, through the counter shaft 50, counter gear 54 output shaft 30 and differential gear device 38, for example.

The first output-side rotary member 70a has, in its surface that is opposed to the input-side rotary member 68 in the axial direction, a plurality of first recessed portions 78a each of which is recessed in a direction away from the input-side rotary member 68. The first recessed portions 78a, whose number is the same as the first receiving portions 76a, are equi-angularly spaced apart from each other in the circumferential direction. The first recessed portions 78a are substantially aligned with the first receiving portions 76a provided in the input-side rotary member 68, in a radial direction of the first output-side rotary member 70a. Therefore, when each of the first receiving portions 76a is aligned with one of the first recessed portions 78a in the circumferential direction, namely, when a rotational position of each of the first receiving portions 76a coincides with that of one of the first recessed portions 78a, the first receiving portion 76a and the first recessed portion 78a are opposed to and adjacent with each other in the axial direction. Each of the first recessed portions 78a has a shape by which a longitudinal end portion of any one of the first struts 72a can be received in the first recessed portion 78a. Further, each of the first recessed portions 78a has, in its circumferential end, a first wall surface 80a with which the longitudinal end portion of one of the first struts 72a is to be in contact, when the input-side rotary member 68 is rotated in the above-described vehicle forward-running direction (corresponding to the downward direction on the drawing sheet of each of FIGS. 2 and 3) relative to the output-side rotary members 70, by the drive force of the engine 12.

The second output-side rotary member 70b has generally a disk-shaped, and is rotatable about the axis of the counter shaft 50. The second output-side rotary member 70b is unrotatable relative to the counter shaft 50, so as to be rotated integrally with the counter shaft 50. The second output-side rotary member 70b is connected to the drive wheels 14, in a drive-force transmittable manner, through the counter shaft 50, counter gear 54, output shaft 30 and differential gear device 38, for example.

The second output-side rotary member 70b has, in its surface that is opposed to the input-side rotary member 68 in the axial direction, a plurality of second recessed portions 78b each of which is recessed in a direction away from the input-side rotary member 68. The second recessed portions 78b, whose number is the same as the second receiving portions 76b, are equi-angularly spaced apart from each other in the circumferential direction. The second recessed portions 78b are substantially aligned with the second receiving portions 76b provided in the input-side rotary member 68, in a radial direction of the second output-side rotary member 70b. Therefore, when each of the second receiving portions 76b is aligned with one of the second recessed portions 78b in the circumferential direction, namely, when a rotational position of each of the second receiving portions 76b coincides with that of one of the second recessed portions 78b, the second receiving portion 76b and the second recessed portion 78b are opposed to and adjacent with each other in the axial direction. Each of the second recessed portions 78b has a shape by which a longitudinal end portion of any one of the second struts 72b can be received in the second recessed portion 78b. Further, each of the second recessed portions 78b has, in its circumferential end, a second wall surface 80b with which the longitudinal end portion of one of the second struts 72b is to be in contact, when the input-side rotary member 68 is rotated in the above-described vehicle reverse-running direction (corresponding to the upward direction on the drawing sheet of each of FIGS. 2 and 3) relative to the output-side rotary members 70, by the drive force of the engine 12 with the two-way clutch TWC being placed in the lock mode, or when the vehicle 10 is in an inertia running state during the forward running with the two-way clutch TWC being placed in the lock mode.

Each of the first struts 72a is constituted by a plate-like member having a predetermined thickness, and is elongated in the circumferential direction (corresponding to the vertical direction on the drawing sheet), as shown in the cross sectional views of FIGS. 2 and 3. Further, each of the first struts 72a has a predetermined dimension as measured in a direction perpendicular to the drawing sheet of FIGS. 2 and 3.

The longitudinal end portion of each of the first struts 72a is constantly forced or biased, by a corresponding one of the torsion coil springs 73a, toward the first output-side rotary member 70a. Further, each of the first struts 72a is in contact at another longitudinal end portion thereof with a first stepped portion 82a provided in a corresponding one of the first receiving portions 76a, such that the first strut 72a is pivotable about the other longitudinal end portion thereof that is in contact with the first stepped portion 82a. Each of the torsion coil springs 73a is interposed between a corresponding one of the first struts 72a and the input-side rotary member 68, and constantly forces or biases the longitudinal end portion of the corresponding one of the first struts 72a toward the first output-side rotary member 70a.

Owing to the above-described construction, in a state in which the two-way clutch TWC is placed in either the one-way mode or the lock mode, when the input-side rotary member 68 receives the drive force which is transmitted from the engine 12 and which acts in the vehicle forward-running direction, each of the first struts 72a is in contact at the longitudinal end portion with the first wall surface 80a of the first output-side rotary member 70a and is in contact at the other longitudinal end portion with the first stepped portion 82a of the input-side rotary member 68, so that the input-side rotary member 68 and the first output-side rotary member 70a are inhibited from being rotated relative to each other whereby the drive force acting in the vehicle forward-running direction is transmitted to the drive wheels 14 through the two-way clutch TWC. The above-described first struts 72a, torsion coil springs 73a, first receiving portions 76a and first recessed portions 78a (each defining the first wall surface 80a) cooperate to constitute a one-way clutch that is configured to transmit the drive force during the driving state in the forward running of the vehicle 10, and to cut off transmission of the drive force during the driven state in the forward running of the vehicle 10. The one-way clutch practically constitutes the “auxiliary engagement device” recited in the appended claims.

Each of the second struts 72b is constituted by a plate-like member having a predetermined thickness, and is elongated in the circumferential direction (corresponding to the vertical direction on the drawing sheet), as shown in the cross sectional views of FIGS. 2 and 3. Further, each of the second struts 72b has a predetermined dimension as measured in a direction perpendicular to the drawing sheet of FIGS. 2 and 3.

The longitudinal end portion of each of the second struts 72b is constantly forced or biased, by a corresponding one of the torsion coil springs 73b, toward the second output-side rotary member 70b. Further, each of the second struts 72b is in contact at another longitudinal end portion thereof with a second stepped portion 82b provided in one of the second receiving portions 76b, such that the second strut 72b is pivotable about the other longitudinal end portion thereof that is in contact with the second stepped portion 82b. Each of the torsion coil springs 73b is interposed between a corresponding one of the second struts 72b and the input-side rotary member 68, and constantly forces or biases the longitudinal end portion of the corresponding one of the second struts 72b toward the second output-side rotary member 70b.

Owing to the above-described construction, in a state in which the two-way clutch TWC is placed in the lock mode, when the input-side rotary member 68 receives the drive force which is transmitted from the engine 12 and which acts in the vehicle reverse-running direction, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the drive force acting in the vehicle reverse-running direction is transmitted to the drive wheels 14 through the two-way clutch TWC. Further, in the state in which the two-way clutch TWC is placed in the lock mode, when the inertia running is made during running of the vehicle 10 in the forward direction, too, each of the second struts 72b is in contact at the longitudinal end portion with the second wall surface 80b of the second output-side rotary member 70b and is in contact at the other longitudinal end portion with the second stepped portion 82b of the input-side rotary member 68, so that the input-side rotary member 68 and the second output-side rotary member 70b are inhibited from being rotated relative to each other whereby the rotation transmitted from the drive wheels 14 is transmitted toward the engine 12 through the two-way clutch TWC. The above-described second struts 72b, torsion coil springs 73b, second receiving portions 76b and second recessed portions 78b (each defining the second wall surface 80b) cooperate to constitute a one-way clutch that is configured to transmit the drive force acting in the vehicle reverse-running direction, toward the drive wheels 14, and to cut off transmission of the drive force acting in the vehicle forward-running direction, toward the drive wheels 14.

Further, the second output-side rotary member 70b has a plurality of through-holes 88 that pass through the second output-side rotary member 70b in the axial direction. Each of the through-holes 88 is located in a position that overlaps with a corresponding one of the second recessed portions 78b in the axial direction of the counter shaft 50, so that each of the through-holes 88 is in communication at its end with a corresponding one of the second recessed portions 78b. A cylindrical-shaped pin 90 is received in each of the through-holes 88, and is slidable in the through-hole 88. The pin 90 is in contact at one of its axially opposite ends with a pressing plate 74 that constitutes a part of the hydraulic actuator 41, and is in contact at the other of its axially opposite ends with an annular ring 86 that includes a plurality of portions that are located in the respective second recessed portions 78b in the circumferential direction.

The ring 86 is fitted in a plurality of arcuate-shaped grooves 84, each of which is provided in the second output-side rotary member 70b and interconnects between a corresponding adjacent pair of the second recessed portions 78b that are adjacent to each other in the circumferential direction. The ring 86 is movable relative to the second output-side rotary member 70b in the axial direction.

Like the two-way clutch TWC, the hydraulic actuator 41 is disposed on the counter shaft 50, and is located in a position adjacent to the second output-side rotary member 70b in the axial direction of the counter shaft 50. The hydraulic actuator 41 includes, in addition to the pressing plate 74, a plurality of coil springs 92 that are interposed between the counter gear 54 and the pressing plate 74 in the axial direction, and a hydraulic chamber (not shown) to which a working fluid is to be supplied whereby a thrust is generated to move the pressing plate 74 toward the counter gear 54 in the axial direction.

The pressing plate 74 has generally a disk shape, and is disposed to be movable relative to the counter shaft 50 in the axial direction. The pressing plate 74 is constantly forced or biased by the spring 92 toward the second output-side rotary member 70b in the axial direction. Therefore, in a state in which the working fluid is not supplied to the above-described hydraulic chamber of the hydraulic actuator 41, the pressing plate 74 is moved, by biasing force of the spring 92, toward the second output-side rotary member 70b in the axial direction, whereby the pressing plate 74 is in contact with the second output-side rotary member 70b, as shown in FIG. 2. In this state, the pins 90, the ring 86 and the longitudinal end portion of each of the second struts 72b are moved toward the input-side rotary member 68 in the axial direction, as shown in FIG. 2, whereby the two-way clutch TWC is placed in the one-way mode.

In a state in which the working fluid is supplied to the above-described hydraulic chamber of the hydraulic actuator 41, the pressing member 74 is moved, against the biasing force of the spring 90, toward the counter gear 54 in the axial direction, so as to be separated from the second output-side rotary member 70b. In this state, the pins 90, the ring 86 and the longitudinal end portion of each of the second struts 72b are moved, by the biasing force of the torsion coil springs 73b, toward the counter gear 54 in the axial direction, as shown in FIG. 3, whereby the two-way clutch TWC is placed in the lock mode.

In the state in which the two-way clutch TWC is placed in the one-way mode, as shown in FIG. 2, the pressing plate 74 is in contact with the second output-side rotary member 70b by the biasing force of the spring 92. In this state, the pins 90 are forced, by the pressing plate 74, to be moved toward the input-side rotary member 68 in the axial direction, and the ring 86 is forced, by the pins 90, to be moved toward the input-side rotary member 68 in the axial direction. Consequently, the longitudinal end portion of each of the second struts 72b is forced, by the ring 86, to be moved toward the input-side rotary member 68, so as to be blocked from being in contact with the second wall surface 80b, whereby the input-side rotary member 68 and the second output-side rotary member 70b are allowed to be rotated relative to each other so that the second struts 72b do not serve as a one-way clutch. Meanwhile, the longitudinal end portion of each of the first struts 72a is biased, by the corresponding coil spring 73a, toward the first output-side rotary member 70a, whereby the longitudinal end portion of each of the first struts 72a can be bought into contact with the first wall surface 80a of any one of the first recessed portions 78a so that the first struts 72a serve as a one-way clutch configured to transmit the drive force acting in the vehicle forward-running direction. That is, the first struts 72a serve as the one-way clutch that is configured to transmit the drive force during the driving state in the forward running of the vehicle 10, and to cut off transmission of the drive force during the driven state in the forward running of the vehicle 10.

In the state in which the two-way clutch TWC is placed in the one-way mode, as shown in FIG. 2, the longitudinal end portion of each of the first struts 72a can be brought into contact with the first wall surface 80a of the first output-side rotary member 70a. Therefore, in the state of the one-way mode of the two-way clutch TWC, when the vehicle 10 is placed in the driving state in which the drive force acting in the vehicle forward-running direction is transmitted from the engine 12 to the two-way clutch TWC, the longitudinal end portion of each of the first struts 72a is in contact with the first wall surface 80a and the other longitudinal end portion of each of the first struts 72a is in contact with the first stepped portion 82a, so that the input-side rotary member 68 is inhibited from being rotated relative to the first output-side rotary member 70a in the vehicle forward-running direction whereby the drive force of the engine 12 is transmitted to the drive wheels 14 through the two-way clutch TWC. On the other hand, in the state of the one-way mode of the two-way clutch TWC, when the vehicle 10 is placed in the driven state by inertia running during the forward running, the input-side rotary member 68 is allowed to be rotated relative to the first output-side rotary member 70a in the vehicle reverse-running direction, without the longitudinal end portion of each of the first struts 72a being in contact with the first wall surface 80a, whereby the transmission of the drive force through the two-way clutch TWC is blocked. Thus, in the state in which the two-way clutch TWC is placed in the one-way mode, the first struts 72a serve as the one-way clutch which is configured to transmit the drive force in the driving state of the vehicle 10 in which the drive force acting in the vehicle forward-running direction is transmitted from the engine 12, and which is configured to block transmission of the drive force in the driven state of the vehicle 10 which is placed by inertia running during the forward running. In other words, the input-side rotary member 68 as the input-side rotary portion is inhibited from being rotated in the vehicle forward-running direction (as a predetermined one of opposite directions) relative to the output-side rotary members 70 as the output-side rotary portion, and is allowed to be rotated in the vehicle reverse-running direction (as the other of the opposite directions) relative to the output-side rotary members 70 as the output-side rotary portion, when the two-way clutch TWC is placed in the one-way mode.

In the state in which the two-way clutch TWC is placed in the lock mode, as shown in FIG. 3, the working fluid is supplied to the hydraulic chamber of the hydraulic actuator 41 whereby the pressing plate 74 is moved, against the spring 92, in a direction away from the second output-side rotary member 70b, and the longitudinal end portion of each second strut 72b is moved, by biasing force of the corresponding torsion coil spring 73b, toward the corresponding second recessed portion 78b of the second output-side rotary member 70b, whereby the longitudinal end portion of each second strut 72b can be brought into contact with the second wall surface 80b of the second output-side rotary member 70b. Meanwhile, each first strut 72a can be brought into contact at the longitudinal end portion with the first wail surface 80a of the first output-side rotary member 70a, as in the state of the one-way mode shown in FIG. 2.

In the state in which the two-way clutch TWC is placed in the lock mode, as shown in FIG. 3, when the drive force acting in the vehicle forward-running direction is transmitted to the input-side rotary member 68, the longitudinal end portion of each first strut 72a is brought into contact with the first wall surface 80a of the first output-side rotary member 70a, and the other longitudinal end portion of each first strut 72a is brought into contact with the first stepped portion 82a of the input-side rotary member 68, whereby the input-side rotary member 68 is inhibited from being rotated relative to the first output-side rotary member 70a in the vehicle forward-running direction. In the state of the lock mode of the two-way clutch TWC, when the drive force acting in the vehicle reverse-running direction is transmitted to the input-side rotary member 68, the longitudinal end portion of each second strut 72b is brought into contact with the second wall surface 80b of the second output-side rotary member 70b, and the other longitudinal end portion of each second strut 72b is brought into contact with the second stepped portion 82b of the input-side rotary member 68, whereby the input-side rotary member 68 is inhibited from being rotated relative to the second output-side rotary member 70b in the vehicle reverse-running direction. Thus, in the state of the lock mode of the two-way clutch TWC, the first struts 72a serve as a one-way clutch and the second struts 72b serve as a one-way clutch, so that the two-way clutch TWC is configured to transmit the drive force acting in the vehicle forward-running direction and the drive force acting in the vehicle reverse-running direction. In other words, the input-side rotary member 68 as the input-side rotary portion is inhibited from being rotated in both of the opposite directions relative to the output-side rotary members 70 as the output-side rotary portion, when the two-way clutch TWC is placed in the lock mode. When the vehicle 10 is to run in reverse direction, the vehicle 10 is enabled to run in reverse direction with the two-way clutch TWC being placed in the lock mode. Further, when the vehicle 10 is placed in the driven state by inertia running during the forward running, an engine brake can be generated with the two-way clutch TWC being placed in the lock mode by which the engine 12 is dragged by rotation transmitted from the drive wheels 14 to the engine 12 through the two-way clutch TWC. Thus, in the state of the lock mode of the two-way clutch TWC, the first struts 72a serve as a one-way clutch and the second struts 72b serve as a one-way clutch, so that the two-way clutch TWC is configured to transmit the drive force during the driving state and the driven state of the vehicle 10.

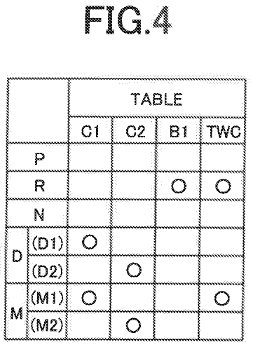

FIG. 4 is a table indicating an operation state of each of the engagement devices for each of a plurality of operation positions POSsh which is selected by operation of a manually-operated shifting device in the form of a shift lever that is provided in the vehicle 10. In FIG. 4, “C1” represents the first clutch C1, “C2” represents the second clutch C2, “B1” represents the first brake B1, and “TWC” represents the two-way clutch TWC. Further, “P”, “R”, “N”, “D” and “M” represent a a parking position P, a reverse position R, a neutral position N, a drive position D and a manual position M, respectively, as the plurality of operation positions POSsh, each of which is to be selected by operation of the shift lever. In the table of FIG. 4, “O” in the first clutch C1, second clutch C2 or first brake B1 indicates its engaged state, and blank in the first clutch C1, second clutch C2 or first brake B1 indicates its released state. Further, in the table of FIG. 4, “O” in the two-way clutch TWC indicates its lock mode, and blank in the two-way clutch TWC indicates its one-way mode.

For example, when the shift lever is placed in the parking position P as one of the operating positions POSsh that is a vehicle stop position or in the neutral position N as one of the operating positions POSsh that is a drive-force transmission block position, the first clutch C1, second clutch C2 and first brake B1 are placed in the released positions, as indicated in FIG. 4, so that the drive-force transmitting apparatus 16 is placed in its neutral state in which the drive force is not transmitted along either the first drive-force transmitting path PT1 or the second drive-force transmitting path PT2.

When the shift lever is placed in the reverse position R as one of the operating positions POSsh that is a reverse running position, the first brake B1 is placed in the engaged state and the two-way clutch TWC is placed in the lock mode, as indicated in FIG. 4. With the first brake B1 being placed in the engaged state, the drive force acting in the vehicle reverse-running direction is transmitted from the engine 12 to the gear mechanism 28. In this instance, if the two-way clutch TWC is in the one-way mode, the drive force is blocked by the two-way clutch TWC so that reverse running cannot be made. Thus, with the two-way clutch TWC being placed in the lock mode, the drive force acting in the vehicle reverse-running direction is transmitted to the output shaft 30 through the two-way clutch TWC so that reverse running can be made. When the shift lever is placed in the reverse position R, the first brake B1 is placed in the engaged state and the two-way clutch TWC is placed in the lock mode, whereby a reverse gear position is established to transmit the drive force acting in the vehicle reverse-running direction, through the gear mechanism 28 along the first drive-force transmitting path PT1, to the drive wheels 14.

When the shift lever is placed in the drive position D as one of the operating positions POSsh that is a forward running position, the first clutch C1 is placed in the engaged state or the second clutch C2 is placed in the engaged state, as indicated in FIG. 4. In FIG. 4, “D1” and “D2” represent a drive position D1 and a drive position D2, respectively, which are operating positions virtually set in control. When the shift lever is placed in the drive position D, one of the drive position D1 and the drive position D2 is selected depending a running state of the vehicle 10, and the selected one is automatically established. The drive position D1 is established when the vehicle running speed is within a relatively low speed range including zero speed (vehicle stop). The drive position D2 is established when the vehicle running speed is within a relatively high speed range including a middle speed range. For example, during running of the vehicle 10 with the shift lever being placed in the drive position D, when the running state of the vehicle 10 is changed from the low speed range to the high speed range, the drive position D1 is automatically switched to the drive position D2.

For example, when the running state of the vehicle 10 is in a speed range corresponding to the drive position D1 upon placement of the shift lever into the drive position D, the first clutch C1 is engaged and the second clutch C2 is released. In this case, a forward-running gear position is established whereby the drive force acting in the vehicle forward-running direction is transmitted from the engine 12 to the drive wheels 14 along the first drive-force transmitting path PT1 through the gear mechanism 28. The two-way clutch TWC, which is placed in the one-way mode, transmits the drive force acting in the vehicle forward-running direction, toward the drive wheels 14.

Further, when the running state of the vehicle 10 is in a speed range corresponding to the drive position D2 upon placement of the shift lever into the drive position D, the first clutch C1 is released and the second clutch C2 is engaged. In this case, a forward-running continuously-variable shifting position is established whereby the drive force acting in the vehicle forward-running direction is transmitted from the engine 12 to the drive wheels 14 along the second drive-force transmitting path PT2 through the continuously variable transmission 24. With the forward-running continuously-variable shifting position being established, the vehicle 10 is enabled to run with execution of shifting actions in the continuously variable transmission 24. Thus, when the shift lever is placed into the drive position D as one of the operating positions POSsh, the drive force of the engine 12 is transmitted to the drive wheels 14 along a selected one of the first and second drive-force transmitting paths PT1, PT2, which is selected depending on the running state of the vehicle 10.

When the shift lever is placed in the manual position M as one of the operating positions POSsh, a shift-up operation or a shift-down operation can be executed by a manual operation made by an operator of the vehicle 10. That is, the manual position M is a manual shift position in which a shifting operation can be made by the manual operation made by the operator. For example, when a shift-down operation is manually made by the operator with the shift lever being placed in the manual position M, the first clutch C1 is placed into the engaged state and the two-way clutch TWC is placed into the lock mode whereby the forward-running gear position is established. With the two-way clutch TWC being placed in the lock mode, the drive force can be transmitted through the two-way clutch TWC during the driven state of the vehicle 10 as well as during the driving state of the vehicle 10. During the inertia running, for example, the vehicle 10 is placed in the driven state in which the rotation is transmitted from the drive wheels 14 toward the engine 12. In the driven state, when the shift-down operation is manually executed with the shift lever being placed in the manual position M, the rotation transmitted from the drive wheels 14 is transmitted toward the engine 12 through the two-way clutch TWC that is placed in the lock mode, whereby the engine 12 is dragged to generate an engine brake. Thus, when the shift-down operation is executed with the shift lever being placed in the manual position M, the forward-running gear position is established so that the drive force is transmitted to the drive wheels 14 along the first drive-force transmitting path PT1 through the gear mechanism 28, and so that the rotation transmitted from the drive wheels 14 is transmitted toward the engine 12 along the first drive-force transmitting path PT1 so as to generate the engine brake during the inertia running

When a shift-up operation is manually made by the operator with the shift lever being placed in the manual position M, the second clutch C2 is placed into the engaged state whereby the forward-running continuously-variable shifting position is established so that the drive force is transmitted to the drive wheels 14 along the second drive-force transmitting path PT2 through the continuously variable transmission 24. Thus, with the shift lever being placed in the manual position M, a manual shifting can be executed by manual operation made by the operator, to select one of the forward-running gear position and the forward-running continuously-variable shifting position. When the forward-running gear position is selected, the drive force can be transmitted along the first drive-force transmitting path PT1. When the forward-running continuously-variable shifting position is selected, the drive force can be transmitted along the second drive-force transmitting path PT2. The case in which the shift-down operation has been made with the shift lever being placed in the manual position M, corresponds to “M1” (position M1) that is shown in FIG. 4. The case in which the shift-up operation has been made with the shift lever being placed in the manual position M, corresponds to “M2” (position M2) that is shown in FIG. 4. Although the positions M1, M2 do not exist in appearance, for the purpose of convenience in the following description, it will be described that “the position M1 is established” when the shift-down operation has been manually made with the shift lever being placed in the manual position M, and it will be described that “the position M2 is established” when the shift-up operation has been manually made with the shift lever being placed in the manual position M.

As indicated in the table of FIG. 4, the first clutch C1 is placed in its engaged sate only when the forward-running gear position (corresponding to the drive position D1 and position M1 shown in FIG. 4) is to be establish to enable the drive force to be transmitted along the first drive-force transmitting path PT1. In other words, the first clutch C1 is not engaged when a gear position other than the forward-running gear position is to be established.

FIG. 5 is a view schematically showing the hydraulic control unit 46 configured to control operation states of the continuously variable transmission 24 and the drive-force transmitting apparatus 16. As shown in FIG. 5, the primary pulley 60 constituting the continuously-variable transmission 24 includes a fixed sheave 60a connected to the primary shaft 58, a movable sheave 60b unrotatable about an axis of the primary shaft 58 and axially movable relative to the fixed sheave 60a, and a primary thrust applies in the form of a hydraulic actuator 60c configured to apply a primary thrust Wpri to the movable sheave 60b. The primary thrust Wpri is a thrust (=primary pressure Ppri*pressure receiving area) for changing a width of a V-shaped groove defined between the fixed and movable sheaves 60a, 60b of the primary pulley 60. That is, the primary thrust Wpri is a thrust applied to the primary pulley 60 from the hydraulic actuator 60c, to clamp the transmission belt 66 that is mounted on the primary pulley 60. The primary pressure Ppri is a hydraulic pressure applied from the hydraulic control unit 46 to the hydraulic actuator 60c, and serves as a pulley hydraulic pressure for generating the primary thrust Wpri.

Meanwhile, the secondary pulley 64 includes a fixed sheave 64a connected to the secondary shaft 62, a movable sheave 64b unrotatable about an axis of the secondary shaft 62 and axially movable relative to the fixed sheave 64a, and a secondary thrust applier in the form of a secondary hydraulic actuator 64c configured to apply a secondary thrust Wsec to the movable sheave 64b. The secondary thrust Wsec is a thrust (=secondary pressure Psec*pressure receiving area) for changing a width of a V-shaped groove defined between the fixed and movable sheaves 64a, 64b of the secondary pulley 64. That is, the secondary thrust Wsec is a thrust applied to the secondary pulley 64 from the secondary hydraulic actuator 64c, to clamp the transmission belt 66 that is mounted on the secondary pulley 64. The secondary pressure Psec is a hydraulic pressure applied from the hydraulic control unit 46 to the secondary hydraulic actuator 64c, and serves as a pulley hydraulic pressure for generating the secondary thrust Wsec.

In the continuously-variable transmission mechanism 24, the primary and secondary pressures Ppri, Psec are controlled by the hydraulic control unit 46 that is controlled by the electronic control apparatus, whereby the primary and secondary thrusts Wpri, Wsec are respectively controlled. With the primary and secondary thrusts Wpri, Wsec being controlled, the widths of the V-shaped grooves of the respective pulleys 60, 64 are controlled to be changeable whereby a belt winding dimeter (effective diameter) of each of the pulleys 60, 64 is changeable and accordingly a gear ratio γcvt (=primary rotational speed Npri/secondary rotational speed Nsec) of the continuously-variable transmission mechanism 24 is changeable. Further, with the primary and secondary thrusts Wpri, Wsec being controlled, the belt clamping force is controlled such that slipping of the transmission belt 66 is not caused. That is, with the primary and secondary thrusts Wpri, Wsec being controlled, the gear ratio γcvt of the continuously-variable transmission mechanism 24 is controlled to a target gear ratio γcvttgt while the transmission belt 66 is prevented from being slipped. It is noted that the primary rotational speed Npri represents a rotational speed of the primary shaft 58, input shaft 22 and primary pulley 60, and that the secondary rotational speed Nsec represents a rotational speed of the secondary shaft 62 and secondary pulley 64.

The hydraulic control unit 46 is constituted to include a plurality of control valves such as electromagnetic valves in the form of solenoid valves. The plurality of solenoid valves include an on-off solenoid valve 100 configured to control a C1 control pressure Pc1 that is applied to a hydraulic actuator C1a of the first clutch C1 and a linear solenoid valve 102 configured to control a C2 control pressure Pc2 that is applied to a hydraulic actuator C2a of the second clutch C2. The on-off solenoid valve 100 is a simple solenoid valve that is to be placed in either one of an open position and a closed position, without an operation position intermediate between the open and closed positions. It is noted that the on-off solenoid valve 100 and the linear solenoid valve 102, which are known solenoid valves, will not be described in detail.

Although not being shown in FIG. 5, the hydraulic control unit 46 includes a plurality of solenoid valves configured to control a B1 control pressure Pb1 that is applied to a hydraulic actuator B1a of the first brake B1, a TWC pressure Ptwc that is applied to the hydraulic actuator 41 so as to switch the two-way clutch TWC between the one-way mode and the lock mode, a primary pressure Ppri that is applied to the hydraulic actuator 60c of the primary pulley 60, a secondary pressure Psec that is applied to the hydraulic actuator 64c of the secondary pulley 64, and a LU pressure Plu that is applied for controlling the lock-up clutch LU. In the present embodiment, each of the solenoid valves configured to control these hydraulic pressures is constituted by a linear solenoid valve.

As described above, the C1 control pressure Pc1, which is applied to the hydraulic actuator C1a of the first clutch C1, is controlled by the on-off solenoid valve 100. The on-off solenoid valve 100 is configured to receive an original pressure in the form of a modulator pressure PM that is regulated by a modulator valve (not shown), and to output the C1 control pressure Pc1 that is applied to the hydraulic actuator C1a. For example, when the on-off solenoid valve 100 is placed in its ON state, the modulator pressure PM is outputted as the C1 control pressure Pc1. When the on-off solenoid valve 100 is placed in its OFF state, the working fluid of the hydraulic actuator C1a is discharged whereby the C1 control pressure Pc1 is reduced to zero. In the on-off solenoid valve 100, the C1 control pressure Pc1 cannot be finely controlled due to the construction of the on-off solenoid valve 100. It is noted that a hydraulic circuit of the hydraulic control unit 46 is arranged such that the on-off solenoid valve 100 is connected only to the hydraulic actuator C1a of the first clutch C1, and is not connected to hydraulic actuators of other engagement devices other than the first clutch C1.

The C2 control pressure Pc2, which is applied to the hydraulic actuator C2a of the second clutch C2, is controlled by the linear solenoid valve 102. The linear solenoid valve 102 is configured to receive an original pressure in the form of the modulator pressure PM, and is capable of finely controlling the C2 control pressure Pc2 that is applied to the hydraulic actuator C2a, based on an electrical signal (command electric current) supplied to the linear solenoid valve 102.

By the way, during running of the vehicle 10, when the drive-force transmitting path PT is to be switched between the first and second drive-force transmitting paths PT1, PT2, one of the first and second clutches C1, C2 is released while the other is engaged in the switching transition. Since the C1 control pressure Pc1 applied to the first clutch C1 cannot be finely controlled by the on-off solenoid valve 100, it is not possible to execute a so-called “clutch-to clutch control” that requires both of the C1 control pressure Pc1 applied to the first clutch C1 and the C2 control pressure Pc2 applied to the second clutch C2, to be finely controlled. Therefore, there is a risk of generation of a shock in the switching transition of the drive-force transmitting path PT. However, in the present embodiment in which the first clutch C1 and the two-way clutch TWC that are provided in the first drive-force transmitting path PT1 are connected to each other in series, the generation of a shock can be avoided in the process of the switching of the drive-force transmitting path PT between the first and second drive-force transmitting paths PT1, PT2, by causing the two-way clutch TEC to act as a one-way clutch, even if the C1 control pressure Pc1 cannot be finely controlled. Hereinafter, there will be described operations executed when the drive-force transmitting path PT is to be switched between the first and second drive-three transmitting paths PT1, PT2. It is noted the following description is applied to a case in which the two-way clutch TWC is placed in its one-way mode so as to act as a one-way clutch.

During forward running of the vehicle 10, when the drive-force transmitting path PT is to be switched from the first drive-force transmitting path PT1 to the second drive-three transmitting path PT2, namely, when the second drive-force transmitting path PT2 is to be established in place of the first drive-force transmitting path PT1, the C2 control pressure Pc2 applied to the second clutch C2 is increased. In this instance, the C2 control pressure Pc2 is finely controlled by the linear solenoid valve 102 such that the C2 control pressure Pc2 is increased at an appropriate rate. With increase of C2 control pressure Pc2, a torque capacity of the second clutch C2 is increased whereby a torque transmittable along the second drive-force transmitting path PT2 through the second clutch C2 is increased. When all torque becomes to be transmittable along the second drive-force transmitting path. PT2, the input-shaft rotational speed Nin is made so low that the rotational speed of the input-side rotary member 68 of the two-way clutch TWC in the vehicle forward-running direction is made lower than the rotational speed of the output-side rotary members 70 of the two-way clutch TWC in the vehicle forward-running direction, namely, the input-side rotary member 68 is rotated relative to the output-side rotary members 70 in the vehicle reverse-running direction, whereby the transmission of the drive force through the two-way clutch TWC is cut off, namely, the first drive-force transmitting path PT1 is disconnected by the two-way clutch TWC, so that the drive-force transmitting path PT is switched from the first drive-force transmitting path PT1 to the second drive-force transmitting path PT2. Thus, with the two-way clutch TWC being switched from a drive-force transmittable state to a drive-force non-transmittable state at an appropriate timing as a result of the increase of the C2 control pressure Pc2, it is possible to minimize or reduce the shock generated in the switching transition of the drive-force transmitting path PT from the first drive-force transmitting path PT1 to the second drive-force transmitting path PT2.

Further, during forward running of the vehicle 10, when the drive-force transmitting path PT is to be switched from the second drive-force transmitting path PT2 to the first drive-force transmitting path PT1, namely, when the first drive-force transmitting path PT1 is to be established in place of the second drive-three transmitting path PT2, the C2 control pressure Pc2 applied to the second clutch C2 is reduced. In this instance, the C2 control pressure Pc2 is finely controlled by the linear solenoid valve 102 such that the C2 control pressure Pc2 is reduced at an appropriate rate. With reduction of the C2 control pressure Pc2, an engine rotational speed Ne of the engine 12 is increased, and the input-shaft rotational speed Nin of the input shaft 22 and an input rotational speed Ntwcin of the input-side rotary member 68 of the two-way clutch TWC are also increased together with the increase of the engine rotational speed Ne. Then, when the input rotational speed Ntwcin reaches an output rotational speed Ntwcout of the output-side rotary members 70 of the two-way clutch TWC, the cutting off of the transmission of the drive force through the two-way clutch TWC is canceled whereby the drive force becomes transmitted along the first drive-force transmitting path PT1 through the two-way clutch TWC. Thus, with the two-way clutch TWC being switched from the drive-force non-transmittable state to the drive-force transmittable state at an appropriate timing as a result of the reduction of the C2 control pressure Pc2, it is possible to minimize or reduce the shock generated in the switching transition of the drive-force transmitting path PT from the second drive-force transmitting path PT2 to the first drive-force transmitting path PT1. Therefore, with the two-way clutch TWC serving as the one-way clutch in the switching transition, it is possible to minimize or reduce the shock generated in the switching transition of the drive-force transmitting path PT between the first drive-force transmitting path PT1 and the second drive-force transmitting path PT2, although the C1 control pressure Pc1 cannot be finely controlled.

Further, when the vehicle 10 is to start to run, the first clutch C1 is engaged so as to enable the vehicle 10 to start to run by the drive force transmitted along the first drive-force transmitting path PT1. In this instance, too, there is a risk of generation of a shock upon start of running of the vehicle 10, because the C1 control pressure Pc1 cannot be finely controlled by the on-off solenoid valve 100. However, in the present embodiment, when the vehicle 10 is to start to run, a so-called “squat control” is executed. In the vehicle running start with execution of the squat control, the first clutch C1 is engaged after the second clutch C2 has been engaged, and then the second clutch C2 is released When the engagement of the first clutch C1 has been completed. With the execution of the squat control, an output torque of the output shaft 30 can be changed gradually whereby the shock is reduced upon the vehicle running start. It is noted that the squat control, which is a known technique, will not be described in detail.

As described above, although a solenoid valve, which is provided to control the C1 control pressure Pc1 applied to the first clutch C1, is constituted by the on-off solenoid valve 100, the two-way clutch TWC is caused to serve as a one-way clutch in the switching transition of the drive-force transmitting path PT, and the squat control is executed in the vehicle running start, so that the shock generation is reduced as in an arrangement in which the C1 control pressure Pc1 applied to the first clutch C1 is controlled by a linear solenoid valve. That is, it is possible to perform a running as if the on-off solenoid valve 100 is replaced by a linear solenoid valve.

The on-off solenoid valve 100 is isolated from the hydraulic actuators of the engagement devices (e.g. the second clutch C2, the first brake B1) that are other than the first clutch C1, so that the on-off solenoid valve 100 never controls the hydraulic pressures applied to the hydraulic actuators of the engagement devices other than the first clutch C1. Further, the first clutch C1 is not engaged when any gear position other than the forward-running gear position is to be established. Therefore, the hydraulic pressures applied to the engagement devices other than the first clutch C1 do not have to be finely controlled by the on-off solenoid valve 100, and the C1 control pressure Pc1 applied to the first clutch C1 does not have to be finely controlled, so that the on-off solenoid valve 100 can be used as a solenoid valve for controlling the C1 control pressure Pc1 applied to the first clutch C1. Further, since the on-off solenoid valve 100 is used as the solenoid valve for controlling the C1 control pressure Pc1, the manufacturing cost can be made lower than an arrangement in which a linear solenoid valve is used as the solenoid valve for controlling the C1 control pressure Pc1. Still further, since the on-off solenoid valve 100 is made more compact in size than a linear solenoid valve, the hydraulic control unit 46 as a whole can be made compact in size. Moreover, the torque capacity of the first clutch C1 does not have to be finely controlled, the first clutch C1 also can be made by a simple construction. For example, it is possible to eliminate members or the like required for defining a centrifugal-hydraulic-pressure cancel chamber that is to be provided for finely controlling the torque capacity of the first clutch C1.

As described above, in the present embodiment, the first drive-force transmitting path PT1 is provided with the first clutch C1 and the two-way clutch TWC, Owing to this arrangement, although the C1 control pressure Pc1 applied to the first clutch C1 is controlled by the on-off solenoid valve 100, the vehicle 10 is enabled to run in substantially the same manner as in an arrangement in which the C1 control pressure Pc1 applied to the first clutch C1 is controlled by a linear solenoid valve. For example, in the switching transition between the first drive-force transmitting path PT1 and the second drive-force transmitting path PT2, a shock can be reduced by causing the two-way clutch TWC to be operated as a one-way clutch. Thus, the shock can be reduced as in a case in which the above-described clutch-to-clutch control is executed. Further, since a solenoid valve used to control the C1 control pressure Pc1 is constituted by the on-off solenoid valve 100, the manufacturing cost can be made lower than an arrangement in which the solenoid valve used to control the C1 control pressure Pc1 is constituted by a linear solenoid valve.

Further, in the present embodiment, since the on-off solenoid valve 100 is not arranged to control the hydraulic pressures applied to the hydraulic actuators of the engagement devices other than the first clutch C1, it is possible to avoid a shock, which could be generated if the hydraulic pressures applied to the engagement devices other than the first clutch C1 were controlled by the on-off solenoid valve 100.

While the preferred embodiment of this invention has been described in detail by reference to the drawings, it is to be understood that the invention may be otherwise embodied.

For example, in the above-described embodiment, the drive-force transmitting apparatus 16 defines the first and second drive-force transmitting paths ST1, ST2 provided in parallel to each other, such that the first drive-force transmitting path. PT1 is provided with the first clutch C1 and the two-way clutch TWC while the second drive-force transmitting path PT2 is provided with the continuously variable transmission 24 and the second clutch C2. However, the above-described construction or arrangement of the drive-force transmitting apparatus 16 is not essential for the present invention. The present invention is applicable to any drive-force transmitting apparatus that is to be provided in a vehicle, wherein the drive-force transmitting apparatus includes an input shaft, an output shaft and first, second and auxiliary engagement devices, and defines a plurality of drive-force transmitting paths that are provided with the engagement devices.

Further, the present invention is applicable also to a drive-force transmitting apparatus including a step-variable automatic transmission that is constituted by a plurality of planetary gear devices and a plurality of engagement devices. In the step-variable automatic transmission, each one of a plurality of speed positions is selectively established by a corresponding one of combinations of operation states of the engagement devices. It is possible to interpret that the step-variable automatic transmission defines the same number of drive-force transmitting paths as the speed positions established therein wherein each of the different drive-force transmitting paths is to be established when a corresponding one of the speed positions is established. In the step-variable automatic transmission included in the drive-force transmitting apparatus, to which the present invention is applicable, two of the engagement devices corresponding to the first and auxiliary engagement devices are provided in series in one of the drive-force transmitting paths which is to be established when a particular one of the speed positions is established, wherein the engagement device corresponding to the first engagement device is to be operated by a hydraulic pressure controlled by an on-off solenoid valve, and wherein the on-off solenoid valve is configured to control exclusively the hydraulic pressure applied to the engagement device corresponding to the first engagement device. That is, the present invention is applicable to such a drive-force transmitting apparatus, particularly, to a case in which a shifting action is executed to switch from the above-described particular one of the speed positions to another of the speed positions, or to switch to the above-described particular one of the speed positions from another of the speed positions. In such a case, too, a shock generated in a process of the shifting action can be reduced by the auxiliary engagement device. Further, the use of the on-off solenoid valve in place of the linear solenoid valve advantageously reduces the manufacturing cost as in the above-described embodiment.

In the above-described embodiment, the on-off solenoid valve 100, which is configured to control the C1 control pressure Pc1 applied to the first clutch C1, is arranged such that the on-off solenoid valve 100 does not control the hydraulic pressures applied to the engagement devices other than the first clutch C1. However, the on-off solenoid valve 100 may be arranged to control a hydraulic pressure applied to a valve or the like, wherein the applied hydraulic pressure does not need to be finely controlled. For example, the on-off solenoid valve 100 may be arranged to output a signal supplied to a selector valve under a certain condition or conditions, wherein the selector valve is provided to establish a selected one of a plurality of fluid passages through which a working fluid is to pass.

In the above-described embodiment, the auxiliary engagement device is constituted by the two-way clutch TWC that is to be placed in a selected one of the one-way mode and the lock mode, such that the two-way clutch TWC transmits the drive force during the driving state of the vehicle 10 and cuts off transmission of the drive force during the driven state of the vehicle 10 when the two-way clutch TWC is placed in the one-way mode, and such that the two-way clutch TWC transmits the drive force during the driving state and during the driven state when the two-way clutch TWC is placed in the lock mode. However, the auxiliary engagement device does not necessarily have to be constituted by a two-way clutch having such a construction, but may he constituted, for example, by a conventional one-way clutch that is configured to transmit the drive force during the driving state and to cut off transmission of the drive force during the driven state. Further, where the auxiliary engagement device is constituted by a two-way clutch, the two-way clutch may have a construction that is not particularly limited to the details of the above-described two-way clutch TWC.

In the above-described embodiment, the hydraulic pressure outputted from the on-off solenoid valve 100 is directly applied as the C1 control pressure Pc1 to the hydraulic actuator C1a of the first clutch C1. However, the hydraulic pressure outputted from the on-off solenoid valve 100 may be applied as a signal pressure to a pressure regulator valve by which the C1 control pressure Pc1 is to be controlled. The present invention is applicable also to such a modified arrangement in which the C1 control pressure Pc1 applied to the first clutch C1 is controlled indirectly controlled by the on-off solenoid valve 100 through the pressure regulator valve. In this modified arrangement (in which the C1 control pressure Pc1 is controlled through the pressure regulator valve), either, the C1 control pressure Pc1 cannot be finely controlled since the on-off solenoid valve 100 is not capable of finely control a hydraulic pressure.

It is to be understood that the embodiment described above is given for illustrative purpose only, and that the present invention may be embodied with various modifications and improvements which may occur to those skilled in the art.

### Nomenclature of Elements

16: drive-force transmitting apparatus
22: input shaft
24: continuously variable transmission
28: gear mechanism
30: output shaft
100: on-off solenoid valve.
102: linear solenoid valve
C1: first clutch (first engagement device, engagement device)
C2: second clutch (second engagement device, engagement device)
TWC: two-way clutch (auxiliary engagement device, engagement device)
PT1: first drive-force transmitting path (one of drive-force transmitting paths)
PT2: second drive-force transmitting path (one of drive-force transmitting paths)

What is claimed is:

1. A drive-force transmitting apparatus that is to be provided in a vehicle, said drive-force transmitting apparatus comprising:
an input shaft, an output shaft, a first engagement device and an auxiliary engagement device,
wherein said drive-force transmitting apparatus defines a plurality of drive-force transmitting paths that are provided between said input shaft and said output shaft,
wherein said plurality of drive-force transmitting paths include a first drive-force transmitting path that is provided with said first engagement device and said auxiliary engagement device, such that said auxiliary engagement device is located between said first engagement device and said output shalt in said first drive-force transmitting path,
wherein said first drive-force transmitting path is established by engagement of said first engagement device operated by a hydraulic pressure which is applied to said first engagement device and which is controlled by an on-off solenoid valve, such that a drive force is to be transmitted along said first drive-force transmitting path through said first and auxiliary engagement devices when said first drive-force transmitting path is established, and
wherein said auxiliary engagement device is configured to transmit the drive force during a driving state of the vehicle and to cut off transmission of the drive force during a driven state of the vehicle.

2. The drive-force transmitting apparatus according to claim 1,
wherein said on-off solenoid valve is isolated from hydraulic actuators of engagement device that are other than said first engagement device.

3. The drive-force transmitting apparatus according to claim 1, further comprising a second engagement device,
wherein said plurality of drive-force transmitting paths further include a second drive-force transmitting path that is established by engagement of said second engagement device operated by a hydraulic pressure which is applied to said second engagement device and which is controlled by a linear solenoid valve, such that the drive force is to be transmitted along the second drive-force transmitting path through the second engagement device when the second drive-force transmitting path is established, and
wherein one of the first and second drive-force transmitting paths is switched to the other of the first and second drive-force transmitting paths, by engagement of a corresponding one of the first and second engagement devices and release of the other of the first and second engagement devices.

4. The drive-force transmitting apparatus according to claim 3, further comprising a continuously-variable transmission,
wherein said first and second drive-force transmitting paths are provided in parallel with each other, and
wherein said second drive-force transmitting path is provided with said continuously-variable transmission.

5. The drive-force transmitting apparatus according to claim 1,
wherein said auxiliary engagement device is to he placed in a selected one of a one-way mode and a lock mode, such that said auxiliary engagement device is configured to transmit the drive force during the driving state of the vehicle and to cut off transmission of the drive force during the driven state of the vehicle when said auxiliary engagement device is placed in the one-way mode, and such that said auxiliary engagement device is configured to transmit the drive force during the driving state of the vehicle and during the driven state of the vehicle when said auxiliary engagement device is placed in the lock mode.

6. The drive-force transmitting apparatus according to claim 1,
wherein said auxiliary engagement device includes an input-side rotary portion and an output-side rotary portion such that rotation is to be transmitted between said input shaft and said input-side rotary portion along said first drive-force transmitting path and such that rotation is to he transmitted between said output-side rotary portion and said output shaft along said first drive-force transmitting path, and
wherein said input-side rotary portion is inhibited from being rotated in a predetermined one of opposite directions relative to said output-side rotary portion and is allowed to he rotated in the other of the opposite directions relative to said output-side rotary portion.

7. The control apparatus according to claim 6,
wherein said input-side rotary portion of said auxiliary engagement device is connected to a first rotary element and is to be rotated integrally with said first rotary element,
wherein said output-side rotary portion of said auxiliary engagement device is connected to a second rotary element and is to be rotated integrally with said second rotary element,
and wherein, when said first and second engagement devices are both engaged and said input shaft is rotated, said first and second rotary elements are both rotated such that a rotational speed of said second rotary element is higher than a rotational speed of said first rotary element, whereby said input-side rotary portion of said auxiliary engagement device is rotated in said other of the opposite directions relative to said output-side rotary portion of said auxiliary engagement device.

8. The drive-force transmitting apparatus according to claim 3,
wherein said second drive-force transmitting path provides a second gear ratio between said input and output shafts, and said first drive-force transmitting path provides a first gear ratio between said input and output shafts, such that the second gear ratio is lower than the first gear ratio.

9. The drive-force transmitting apparatus according to claim 1, comprising a hydraulic control unit that includes said on-off solenoid valve.
